(19) United States
(12) Patent Application Publication
(10) Pub. No.: US 2020/0375222 A1
(43) Pub. Date: Dec. 3, 2020

(54) PYRROLOQUINOLINE QUINONE-CONTAINING ACIDIC BEVERAGE AND METHOD FOR SUPPRESSING DEPOSITION OF PYRROLOQUINOLINE QUINONE

(71) Applicant: Mitsubishi Gas Chemical Company, Inc., Chiyoda-ku (JP)

(72) Inventors: Atsushi SUGIMOTO, Niigata-shi (JP); Kazuto IKEMOTO, Niigata-shi (JP)

(73) Assignee: Mitsubishi Gas Chemical Company, Inc., Chiyoda-ku (JP)

(21) Appl. No.: 16/754,990

(22) PCT Filed: Sep. 14, 2018
(86) PCT No.: PCT/JP2018/034119

§ 371 Date: Apr. 9, 2020

(30) Foreign Application Priority Data
Oct. 25, 2017 (JP) 2017-206347

(51) Int. Cl. A23L 2/56; A23L 29/00; A23L 29/269; A23L 29/30; A23L 2/68

(52) U.S. Cl. CPC A23L 2/56; A23L 29/035; A23L 2/68; A23L 29/37; A23L 29/273

(57) ABSTRACT

Provided is an acidic beverage comprising (A) pyrroloquinoline quinone or a salt thereof, (B) ascorbic acid, and (C) cyclodextrin, wherein all the components are dissolved.

### TECHNICAL FIELD

The present invention relates to an acidic beverage and a method for suppressing deposition.

### BACKGROUND ART

Acidic beverages are highly preferred beverages that have pH in an acidic region and are characterized by modest sourness and refreshing flavor. Ascorbic acid is widely used for adjusting the pH or flavor of such acidic beverages and preventing oxidation.

Pyrroloquinoline quinone is a coenzyme present in bacteria as well as molds and yeasts which are eukaryotes. The possibility has been proposed that the pyrroloquinoline quinone is a novel vitamin. Thus, the pyrroloquinoline quinone has received attention as a substance useful for health supplements, cosmetics, and the like. Also, the pyrroloquinoline quinone has previously been found to have many physiological activities such as a cell growth promoting effect, an anti-cataract effect, a prophylactic or therapeutic effect on liver diseases, a wound healing effect, an antiallergic effect, a reverse transcriptase inhibitory effect and a glyoxalase I inhibitory effect (anticancer effect) (see, for example, Non Patent Literature 1). An inclusion body of pyrroloquinoline quinone with cyclodextrin has previously been reported in order to stabilize the pyrroloquinoline quinone (see, for example, Patent Literature 1).

### CITATION LIST

### Patent Literature

Patent Literature 1: Japanese Patent Laid-Open No. 2012-180319

### Non Patent Literature

Non Patent Literature 1: Biosci Biotechnol Biochem. 2016; 80 (1): 13-22. doi:10.1080/09168451.2015.1062715.

### SUMMARY OF INVENTION

### Technical Problem

The present inventors have conducted studies on pyrroloquinoline quinone-containing acidic beverages and consequently found that a problem of pyrroloquinoline quinone is that deposition occurs in the presence of ascorbic acid.

Accordingly, an object of the present invention is to provide a favorable acidic beverage that is less likely to deposit pyrroloquinoline quinone in the presence of ascorbic acid.

### Solution to Problem

As a result of conducting studies, the present inventors have found that the addition of cyclodextrin to an acidic beverage containing pyrroloquinoline quinone and ascorbic acid suppresses the deposition of the pyrroloquinoline quinone.

The present invention encompasses the following aspects of the invention.

[1]

An acidic beverage comprising:
(A) pyrroloquinoline quinone or a salt thereof;
(B) ascorbic acid; and
(C) cyclodextrin.

[2]

The acidic beverage according to [1], wherein the component (C) is 7-cyclodextrin, and a content thereof is 3 to 13% by weight.

[3]

The acidic beverage according to [1], wherein the component (C) is α-cyclodextrin, and a content thereof is 0.3 to 24% by weight.

[4]

The acidic beverage according to any of [1] to [3], wherein a mass ratio of the component (B) to the component (A) [(B)/(A)] is 1 to 1000.

[5]

The acidic beverage according to any of [1] to [4], wherein the acidic beverage has pH of 2 to 5.4.

[6]

The acidic beverage according to any of [1] to [7], further comprising an acidulant other than ascorbic acid.

[7]

The acidic beverage according to any of [1] to [6], further comprising a sweetener.

[8]

The acidic beverage according to any of [1] to [7], further comprising carbonic acid.

[9]

A method for suppressing the deposition of pyrroloquinoline quinone, comprising the step of bringing pyrroloquinoline quinone or a salt thereof into contact with cyclodextrin in the presence of ascorbic acid.

### Advantageous Effects of Invention

The present invention can provide an acidic beverage that does not deposit pyrroloquinoline quinone even in the presence of ascorbic acid.

### DESCRIPTION OF EMBODIMENTS

Hereinafter, the mode for carrying out the present invention (hereinafter, referred to as the “present embodiment”) will be described in detail. The present invention is not limited by the following embodiments, and can be carried oud through various changes or modifications without departing from the spirit of the present invention.

The acidic beverage according to the first embodiment of the present invention contains (A) pyrroloquinoline quinone and/or a salt thereof, (B) ascorbic acid, (C) cyclodextrin, and optionally (D) an acidulant other than ascorbic acid and an additional component. All the components including pyrroloquinoline quinone are dissolved in the presence of cyclodextrin in the acidic beverage.

The acidic beverage of the present embodiment contains pyrroloquinoline quinone (hereinafter, also referred to as “PQQ”) and/or a salt thereof as a component (A).

In the present embodiment, PQQ is a compound represented by formula 1.

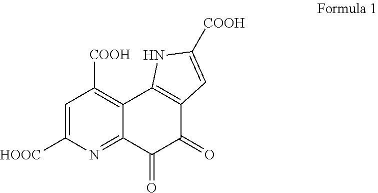 [SMILES: O=C(O)c1cc(C(=O)O)c2c(n1)C(=O)C(=O)c1cc(C(=O)O)[nH]c1-2]

Examples of the salt of PQQ include, but are not particularly limited to, metal salts, for example, monosodium salt, disodium salt, trisodium salt, monopotassium salt, dipotassium salt, tripotassium salt, monolithium salt, dilithium salt, and trilithium salt. Disodium salt is preferred.

When the component (C) is α-cyclodextrin, the content of the component (A) in the acidic beverage of the present embodiment is preferably 5 mg/L to 100 mg/L, more preferably 10 mg/L to 100 mg/L, particularly preferably 10 mg/L to 40 mg/L. When the component (C) is γ-cyclodextrin, the content of the component (A) in the acidic beverage of the present embodiment is preferably 5 mg/L to 550 mg/L, more preferably 10 mg/L to 80 mg/L, particularly preferably 10 mg/L to 40 mg/L.

The content of the component (A) can be measured by an analysis method suitable for the situation of a measurement sample, among usually known methods for analyzing pyrroloquinoline quinone. Specifically, the component (A) can be quantitatively analyzed by liquid chromatography described in Examples mentioned later. A sample containing pyrroloquinoline quinone may be appropriately treated, if necessary. For example, the sample can be freeze-dried for adaptation to the detection range of an apparatus for measurement, or impurities in the sample can be removed for adaptation to the separating ability of an apparatus.

The ascorbic acid serving as the component (B) can be added as an acidulant, an antioxidant, or the like to the acidic beverage. The ascorbic acid is blended thereinto in the same amount or a larger amount than that of the pyrroloquinoline quinone serving as the component (A). Specifically, the mass ratio of the component (B) to the component (A) [(B)/(A)] is preferably 1 to 1000, more preferably 2 to 350, particularly preferably 10 to 100. When the ascorbic acid has a mass ratio of less than 1 to the pyrroloquinoline quinone, no deposition problem arises. On the other hand, if the ascorbic acid has a mass ratio of more than 1000 to the pyrroloquinoline quinone, the balance of taste is deteriorated.

The cyclodextrin used is any of α- and γ-cyclodextrins without limitations. γ-Cyclodextrin is preferred from the viewpoint of a deposition suppressing effect. The content of the γ-cyclodextrin in the acidic beverage is preferably 0.3 to 24% by weight, more preferably 0.4 to 13% by weight, particularly preferably 1 to 10% by weight.

The content of the α-cyclodextrin in the acidic beverage is preferably 3 to 13% by weight, more preferably 5 to 13% by weight, particularly preferably 6 to 10% by weight.

Even if the concentration of the cyclodextrin falls outside the range described above, the cyclodextrin can decrease the occurrence of deposits as compared with the case of adding no cyclodextrin. However, if the concentration of the cyclodextrin falls below the lower limit, the deposition of pyrroloquinoline quinone may be observed. If the concentration of the cyclodextrin exceeds the upper limit, the cyclodextrin itself may be deposited.

Examples of the acidulant (D) include, but are not particularly limited to, citric acid, lactic acid, malic acid, phosphoric acid, and succinic acid. In the acidic beverage of the present embodiment, the acidulant is effective for producing a feeling of refreshment. The content of the acidulant can be appropriately set in terms of gustation, and is, for example, preferably 0.001 to 5% by weight, more preferably 0.01 to 3% by weight, particularly preferably 0.1 to 3% by weight.

The pH of the acidic beverage of the present embodiment is preferably 2 to 5.4, more preferably 2 to 4, particularly preferably 2 to 3. Acidity is necessary for producing a feeling of refreshment. The pH is controllable by blending an appropriate amount of the acidulant thereinto.

The acidic beverage of the present embodiment preferably contains a sweetener. Examples of the sweetener include carbohydrate-based sweeteners and high-intensity sweeteners. In this context, the “high-intensity sweetener” herein means an artificial or natural sweetener that has 10 times to 1000 times the sweetness of sucrose and can impart sweetness to a food or drink by addition in a small amount.

Examples of the carbohydrate-based sweetener include: monosaccharides such as fructose, glucose, tagatose, arabinose, D-psicose, and D-allose; disaccharides such as lactose, trehalose, maltose, sucrose, and cellobiose; and sugar alcohols such as erythritol, xylitol, maltitol, sorbitol, mannitol, maltitol, reduced palatinose, lactitol, and reduced starch saccharification products. Examples of the high-intensity sweetener include sucralose, acesulfame potassium, aspartame, stevia (rebaudioside and stevioside), thaumatin, saccharin, saccharin sodium, licorice extracts, Siraitia grosvenorii extracts, neotame, mabinlin, brazzein, monellin, glycyrrhizin, alitame, sodium cyclohexylsulfamate, dulcin, and neohesperidin. One or two or more of these sweeteners can be used. The high-intensity sweetener is preferably one or two or more members selected from sucralose, acesulfame potassium, aspartame, stevia and thaumatin.

The content of the sweetener is appropriately adjusted according to the degree of sweetness required for a final product. The content of the sweetener is, for example, preferably 1 to 20% by weight, more preferably 1 to 15% by weight, particularly preferably 1 to 10% by weight, in terms of sucrose.

The acidic beverage of the present embodiment can contain carbonic acid in order to impart a feeling of stimulation to its taste.

The content of the carbonic acid is preferably 0.01 to 1% by weight, more preferably 0.1 to 0.5% by weight, particularly preferably 0.3 to 0.4% by weight.

The acidic beverage of the present embodiment may contain an additive that is usually blended into beverages, without inhibiting the desired effect. Examples of such an additive include, but are not particularly limited to, colorants, antioxidants, flavors, salts, and stabilizers. Examples of the colorants can include, but are not particularly limited to, caramel colors, gardenia colors, fruit juice colors, vegetable colors, and synthetic pigments. Examples of the antioxidants can include, but are not particularly limited to, vitamin C, vitamin E, and polyphenol. Examples of the salts can include, but are not particularly limited to, sodium chloride and potassium chloride. Examples of the stabilizers can include, but are not particularly limited to, pectin and water-soluble soybean polysaccharides.

The acidic beverage of the present embodiment may also contain an additional additive according to the type of a final product. Examples of the additional additive include, but are not particularly limited to, eudesmol, inulin, procyanidin C1, nootkatone, methoxyflavone, hydroxytyrosol, theanine, 1-menthol, vanillin, proanthocyanidin, saponin, rutin, capsaicin, fructan, strictinin, astaxanthin, placenta, anthocyanin, glucomannan, arabinoxylan, acrylamide, sphingomyelin, citrulline, furfuryl thiol, isomaltulose, collagen peptide, casein peptide, amino acids (proline, glycine, etc.), L-arabinose, 2,5-piperazinedione,3,6-bis(phenylmethyl), (3S,6S),6-O-PUFA ascorbic acid ester, α-glucan, β-glucan, chlorogenic acid, pyruvic acid, dicaffeoylquinic acid, dehydroascorbic acid, α acid or iso-α acid, β acid, orotic acid, lipoic acid, oligosaccharides (maltooligosaccharide, etc.), isoquercitrin or sugar adducts thereof, hesperidin and sugar adducts of hesperidin, octenyl succinate starch, coenzyme Q10, polymerized or non-polymerized catechins, chlorophylls, theaflavins, malt extracts, plant extracts, aroma extracts, caffeine, turmeric, fruit flavors, fruit juices, and mesophyll.

The acidic beverage of the present embodiment may further contain a functional component other than pyrroloquinoline quinone. Examples of the functional component include, but are not particularly limited to, BCAA (branched chain amino acids), amino acids (histidine, L-serine, essential amino acids containing 40% leucine, etc.), β-cryptoxanthin, DHA (docosahexaenoic acid), EPA (eicosapentaenoic acid), GABA (γ-aminobutyric acid), acetic acid, HMB (bis-3-hydroxy-3-methyl butyrate monohydrate), N-acetylglucosamine, astaxanthin, isoflavone (kudzu (Pueraria) flower-derived isoflavone, etc.), ginkgo leaf terpene lactone, ginkgo leaf flavonoid glycoside, epigallocatechin gallate, methylated catechin, ornithine, cacao flavanol, lactic acid bacteria (Lactobacillus gasseri SBT2055, etc.), bifidobacteria, agar-derived galactan, guar gum decomposition products, glucosamine, glucosylceramide, Plantago psyllium seed coat-derived dietary fiber, Salacia-derived salacinol, tiliroside, sodium hyaluronate, piperine, monoglucosyl hesperidin, lactotripeptide, imidazole dipeptide, lycopene, and apple polyphenol.

The acidic beverage of the present embodiment can be produced, for example, by dissolving the components (A) to (C) mentioned above in water.

The acidic beverage of the present embodiment may be heat-sterilized at the desired timing after preparation. The heat sterilization method is not particularly limited as long as the method is appropriate for conditions stipulated by a law or a regulation (in Japan, Food Sanitation Act) that should be applied thereto. Examples thereof can include a retort sterilization method, a high temperature-short time method (HTST), an ultrahigh temperature method (UHT), and pasteurization.

The heat sterilization method is appropriately selected. For example, retort sterilization or pasteurization can be adopted when a container such as a metal can or a bottle filled with the beverage can be directly heat-sterilized (e.g., 60 to 140° C., 1 to 60 min). For the pasteurization, the heat sterilization can be performed, for example, at 65° C. for 1 to 60 minutes, preferably at 65° C. for 5 to 30 minutes, more preferably at 65° C. for 10 to 20 minutes.

As for a container, such as a PET bottle, which cannot be retort-sterilized, aseptic filling, hot-pack filling, or the like can be adopted which involves heat-sterilizing the beverage in advance under sterilization conditions (e.g., at 65 to 140° C. for 0.1 seconds to 30 minutes, preferably at 70 to 125° C. for 1 second to 25 minutes, more preferably at 75 to 120° C. for 10 seconds to 20 minutes) equivalent to those described above, and filling a sterilized container with the resulting beverage in an aseptic environment.

According to the second embodiment, the present invention provides a method for suppressing the deposition of pyrroloquinoline quinone, comprising the step of bringing pyrroloquinoline quinone or a salt thereof into contact with cyclodextrin in the presence of ascorbic acid.

Each component for use in the method for suppressing deposition is as mentioned above. The amount of each component is appropriately determined according to the desired effect. The method for suppressing deposition may further comprise a step for use in the production of acidic beverages, for example, a step of the filling, sterilization, etc. mentioned above.

### EXAMPLES

The pyrroloquinoline quinone disodium salt used in the present embodiment was BioPQQ(Registered Trademark) manufactured by Mitsubishi Gas Chemical Co., Inc. α-Cyclodextrin and γ-cyclodextrin manufactured by Wako Pure Chemical Industries, Ltd. were used.

### Example 1

An aqueous solution containing 0.3% by weight of ascorbic acid, 0.6% by weight of citric acid, 4.0% by weight of α-cyclodextrin, and 0.008% by weight (80 mg/L) of pyrroloquinoline quinone disodium salt per L was prepared. The ascorbic acid/PQQ disodium salt mass ratio was 37.5. This aqueous solution was used as a pyrroloquinoline quinone-containing acidic beverage. The pH was 2.3. The pyrroloquinoline quinone-containing acidic beverage was preserved at 4° C. for 1 day and evaluated for the presence or absence of the deposition of pyrroloquinoline quinone. The deposition of pyrroloquinoline quinone was not confirmed in the pyrroloquinoline quinone-containing acidic beverage blended with α-cyclodextrin.

### Example 2

A pyrroloquinoline quinone-containing acidic beverage containing 0.3% by weight of ascorbic acid, 0.6% by weight of citric acid, 4.0% by weight of γ-cyclodextrin, and 0.008% by weight (80 mg/L) of pyrroloquinoline quinone disodium salt per L was prepared. The ascorbic acid/PQQ disodium salt mass ratio was 37.5. It was 37.5. The pH was 2.3. This pyrroloquinoline quinone-containing acidic beverage was preserved at 4° C. for 1 day and evaluated for the presence or absence of the deposition of pyrroloquinoline quinone. The deposition of pyrroloquinoline quinone was not confirmed in the acidic beverage blended with γ-cyclodextrin.

### Comparative Example 1

0.3% by weight of ascorbic acid, 0.6% by weight of citric acid, and 0.008% by weight (80 mg/L) of pyrroloquinoline quinone disodium salt were added per L in the same way as in Example 1 or 2 described above except that no cyclodextrin was added, to prepare a pyrroloquinoline quinone-containing acidic beverage. The ascorbic acid/PQQ disodium salt mass ratio was 37.5. The pH was 2.3. When the pyrroloquinoline quinone-containing acidic beverage was preserved at 4° C. for 1 day, deposition occurred as dark red precipitation.

As is evident from these results, the addition of cyclodextrin is effective for suppressing the deposition of pyrroloquinoline quinone in an acidic solution.

### Comparative Examples 2 to 4

An acidic beverage containing 0.3% by weight of ascorbic acid, 0.6% by weight of citric acid, and 0.008% by weight (80 mg/L) of pyrroloquinoline quinone disodium salt per L was prepared in the same way as in Example 1 or 2 described above except that no cyclodextrin was added. The ascorbic acid/PQQ disodium salt mass ratio was 37.5.

Glucose, fructose, or sorbitol was added thereto at 5.0% by weight. The resulting acidic beverages were preserved at 4° C. for 1 day to confirm the presence or absence of deposition. The results are shown in Table 1.

TABLE 1

| | | Presence or absence of |
|---|---|---|
| Comparative Example | Additive | deposition |
| 2 | Glucose | Present |
| 3 | Fructose | Present |
| 4 | Sorbitol | Present |

The deposition suppressing effect is an effect brought about by cyclodextrin and was unable to be achieved by other sugars.

### Example 3

The same experiment as in Example 1 was carried out such that the concentration of α-cyclodextrin was 2.0% by weight. The ascorbic acid/PQQ disodium salt mass ratio was 37.5.

As a result of preserving the acidic beverage at 4° C. for 1 day, deposition occurred as dark red precipitation, the amount of which was however smaller than that of Comparative Example 1.

### Examples 4 and 5

The same experiment as in Example 1 was carried out such that the concentration of γ-cyclodextrin was 1.0 and 2.0% by weight. The ascorbic acid/PQQ disodium salt mass ratio was 37.5.

As a result of preserving the acidic beverages at 4° C. for 1 day, deposition was confirmed in neither of the acidic beverages. The results are shown in Table 2.

TABLE 2

| | | Additive | Presence or |
|---|---|---|---|
| | | concentration | absence of |
| Example | Additive | (% by weight) | deposition |
| 4 | γ-Cyclodextrin | 1.0 | Absent |
| 5 | γ-Cyclodextrin | 2.0 | Absent |

### Example 6

The same experiment as in Example 1 was carried out such that the concentration of γ-cyclodextrin was 0.2% by weight. As a result of preserving the acidic beverage at 4° C. for 1 day, deposition occurred as dark red precipitation, the amount of which was however smaller than that of Comparative Example 1.

### Examples 7 and 8

An acidic aqueous solution containing 0.3% by weight of ascorbic acid, 0.6% by weight of citric acid, and 4.0% by weight of α-cyclodextrin per L was prepared in the same way as in Example 1 described above except that the amount of pyrroloquinoline quinone disodium salt added was changed. To this acidic aqueous solution, pyrroloquinoline quinone disodium salt was added at 0.001% by weight (Example 7) (10 mg/L) or 0.004% by weight (Example 8) (40 mg/L) to prepare acidic beverages. After preservation of the acidic beverages at 4° C. for 1 day, precipitation was confirmed in neither of the acidic beverages. The results are shown in Table 3 below. The ascorbic acid/PQQ disodium salt mass ratio in Example 7 was 300. The ascorbic acid/PQQ disodium salt mass ratio in Example 8 was 75.

TABLE 3

| | | | Presence or |
|---|---|---|---|
| | | PQQ disodium salt | absence of |
| Example | Additive | concentration | deposition |
| 7 | α-Cyclodcxtrin | 10 | Absent |
| 8 | α-Cyclodextrin | 40 | Absent |

### Comparative Example 5

The same experiment as in Examples 7 and 8 was carried out except that the concentration of pyrroloquinoline quinone disodium salt was 0.02% by weight per L. As a result of preserving the acidic beverage at 4° C. for 1 day, deposition occurred as dark red precipitation. The ascorbic acid/PQQ disodium salt mass ratio was 15.

### Examples 9 to 11

An acidic aqueous solution containing 0.3% by weight of ascorbic acid, 0.6% by weight of citric acid, and 2.0% by weight of γ-cyclodextrin was prepared in the same way as in Example 5 described above except that the amount of pyrroloquinoline quinone disodium salt added was changed. To this acidic aqueous solution, pyrroloquinoline quinone disodium salt was added at a concentration per L of 0.001% by weight (Example 9) (10 mg/L), 0.004% by weight (Example 10) (40 mg/L), or 0.02% by weight (Example 11) (200 mg/L) to prepare acidic beverages. After preservation of the acidic beverages at 4° C. for 1 day, precipitation was confirmed in neither of the acidic beverages. The results are shown in Table 4 below.

TABLE 4

| | | PQQ | | Ascorbic |
|---|---|---|---|---|
| | | disodium salt | Presence or | acid/PQQ |
| | | concentration | absence of | disodium |
| Example | Additive | (mg/L) | deposition | salt |
| 9 | γ-Cyclodextrin | 10 | Absent | 300 |
| 10 | γ-Cyclodextrin | 40 | Absent | 75 |
| 11 | γ-Cyclodcxtrin | 200 | Absent | 15 |

The present invention can provide a stable beverage in which the deposition of pyrroloquinoline quinone is suppressed even in the presence of ascorbic acid.

### Example 12

The components given below were added to Wilkinson's carbonated water bottle to prepare a carbonated beverage. 0.5% by weight of table sugar, 0.05% by weight of citric acid, 0.3% by weight of ascorbic acid, 0.4% by weight of γ-cyclodextrin, 0.008% by weight (80 mg/L) of pyrroloquinoline quinone disodium salt, and 0.015% by weight of acesulfame K were added per L. The ascorbic acid/PQQ disodium salt mass ratio was 37.5. The pH was 3. While this beverage was preserved at 4° C., no deposition was confirmed. The beverage was sweet with a feeling of refreshment.

### Comparative Example 6

The components given below were added to Wilkinson's carbonated water bottle to prepare a carbonated beverage. 0.5% by weight of table sugar, 0.05% by weight of citric acid, 0.3% by weight of ascorbic acid, 0.006% by weight (60 mg/L) of pyrroloquinoline quinone disodium salt, and 0.015% by weight of acesulfame K were added per L. The ascorbic acid/PQQ disodium salt mass ratio was 50. The pH was 3. While this beverage was preserved at 4° C., pyrroloquinoline quinone was deposited. The beverage was sweet with a feeling of refreshment.

According to the present embodiment, deposition was also able to be suppressed for the carbonated beverage. Particularly, γ-cyclodextrin was found to have high ability to suppress deposition and prevent deposition of pyrroloquinoline quinone even having a higher concentration. The addition of cyclodextrin was also found to have no influence on taste and be excellent for beverage production.

### Examples 13 to 24

Ascorbic acid, citric acid, α-cyclodextrin (α-CD) or γ-cyclodextrin (γ-CD), and pyrroloquinoline quinone disodium salt (PQQ disodium salt) were added as shown in Tables 5 and 6 to prepare aqueous solutions. These aqueous solutions were used as pyrroloquinoline quinone-containing acidic beverages. The pH of each acidic beverage was 2. The acidic beverages were preserved at 4° C. for 1 day and evaluated for the deposition of the acidic beverage components. The evaluation results are shown in Tables 5 and 6.

TABLE 5

| | | | Ascorbic acid | | |
|---|---|---|---|---|---|
| | | PQQ | (ascorbic acid/PQQ | Citric | |
| Example | α-CD | disodium salt | disodium salt) | acid | Deposition |
| 13 | 10% | 0.008% (80 mg/L) | 0.3% (37.5) | 0.6% | Absent |
| 14 | 12% | 0.008% (80 mg/L) | 0.3% (37.5) | 0.6% | Absent |
| 15 | 14% | 0.008% (80 mg/L) | 0.3% (37.5) | 0.6% | Present |
| 16 | 15% | 0.008% (80 mg/L) | 0.3% (37.5) | 0.6% | Present |

TABLE 6

| | | | | Ascorbic acid | | | |
|---|---|---|---|---|---|---|---|
| | | PQQ | | (ascorbic acid/PQQ | | Citric | |
| Example | γ-CD | disodium salt | | disodium salt) | | acid | Deposition |
| 17 | 20% | 0.008% | (80 mg/L) | 0.3% | (37.5) | 0.6% | Absent |
| 18 | 23% | 0.008% | | 0.3% | (37.5) | 0.6% | Absent |
| 19 | 25% | 0.008% | (80 mg/L) | 0.3% | (37.5) | 0.6% | Present |
| 20 | 4% | 0.024% | (240 mg/L) | 0.3% | (12.5) | 0.6% | Absent |
| 21 | 4% | 0.028% | (280 mg/L) | 0.3% | (10.7) | 0.6% | Absent |
| 22 | 4% | 0.032% | (320 mg/L) | 0.3% | (9.4) | 0.6% | Absent |
| 23 | 4% | 0.036% | (360 mg/L) | 0.3% | (8.3) | 0.6% | Absent |
| 24 | 4% | 0.04% | (400 mg/L) | 0.3% | (7.5) | 0.6% | Absent |

The addition of cyclodextrin at any of the concentrations decreased deposits as compared with the case of adding no cyclodextrin. Particularly, α-cyclodextrin having a concentration of less than 14% completely suppressed deposition. γ-Cyclodextrin having a concentration of less than 25% completely suppressed deposition.

1. An acidic beverage, comprising:
(A) pyrroloquinoline quinone or a salt thereof;
(B) ascorbic acid; and
(C) cyclodextrin.

2. The acidic beverage of claim 1, wherein (C) is α-cyclodextrin, and a content thereof is 3 to 13% by weight.

3. The acidic beverage of claim 1, wherein (C) is γ-cyclodextrin, and a content thereof is 0.3 to 24% by weight.

4. The acidic beverage of claim 1, wherein a mass ratio of (B) to (A) [(B)/(A)] is 1 to 1000.

5. The acidic beverage of claim 1, which has a pH of 2 to 5.4.

6. The acidic beverage of claim 1, further comprising an acidulant other than ascorbic acid.

7. The acidic beverage of claim 1, further comprising a sweetener.

8. The acidic beverage of claim 1, further comprising carbonic acid.

9. A method for suppressing deposition of pyrroloquinoline quinone, the method comprising contacting pyrroloquinoline quinone or a salt thereof with cyclodextrin in the presence of ascorbic acid.
